(19) United States
(12) Patent Application Publication
(10) Pub. No.: US 2010/0332332 A1
(43) Pub. Date: Dec. 30, 2010

(54) METHOD AND APPARATUS FOR FREELY DISTRIBUTING DIGITAL CONTENT WITH ADVERTISEMENT

(75) Inventors: Arto Heikki Tapio Lammintaus, Pirkkala (FI); Yan Fu, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/495,407

(22) Filed: Jun. 30, 2009

(51) Int. Cl. G06Q 30/00; G06F 21/00

(52) U.S. Cl. 705/14.72; 726/30

(57) ABSTRACT

An approach is provided for freely distributing digital content with advertisement. A digital content and advertising platform receives digital content and determines whether to permit free distribution of the digital content. The digital content and advertising platform then generates a digital medium to include the digital content, an advertisement, and a separation criterion for separating the advertisement from the digital content.

### BACKGROUND

Internet and mobile communications are overtaking television and print media as the main advertising media. Mobile advertisements include e-mails, banner ads, coupons, Multimedia Messaging Service (MMS) picture and video messages, advergames and various engagement marketing campaigns.

Existing DRM (Digital Rights Management) technologies are used to protect digital content by not allowing free portability of music, video, games, books, etc. Existing DRM technology does not allow free distribution of the content.

### SOME EXAMPLE EMBODIMENTS

Therefore, there is a need for an approach for freely distributing digital content with advertisement.

According to one embodiment, a method comprises receiving digital content. The method also comprises determining whether to permit free distribution of the digital content. The method further comprises generating a digital medium to include the digital content, an advertisement, and a separation criterion for separating the advertisement from the digital content.

According to another embodiment, an apparatus comprising at least one processor, and at least one memory including computer program code, the at least one memory and the computer program code configured to, with the at least one processor, cause the apparatus to receive digital content. The apparatus is also caused to determine whether to permit free distribution of the digital content. The apparatus is further caused to generate a digital medium to include the digital content, an advertisement, and a separation criterion for separating the advertisement from the digital content.

According to another embodiment, a computer-readable storage medium carrying one or more sequences of one or more instructions which, when executed by one or more processors, cause an apparatus to receive digital content. The apparatus is also caused to determine whether to permit free distribution of the digital content. The apparatus is further caused to generate a digital medium to include the digital content, an advertisement, and a separation criterion for separating the advertisement from the digital content.

According to another embodiment, an apparatus comprises means for receiving digital content. The apparatus also comprises means for determining whether to permit free distribution of the digital content. The apparatus further comprises means for generating a digital medium to include the digital content, an advertisement, and a separation criterion for separating the advertisement from the digital content.

According to another embodiment, a method comprises receiving, from a content provider, a digital medium including digital content, an advertisement, and a separation criterion for separating the advertisement from the digital content. The method also comprises initiating presentation of the digital content and the advertisement. The method further comprises enabling the selection of at least one of (1) having the received medium unmodified and played with a commercial promotion, or (2) sending the received medium unmodified to a user in which the advertisement is removed or masked on the received medium for a predetermined time period.

According to another embodiment, an apparatus comprising at least one processor, and at least one memory including computer program code, the at least one memory and the computer program code configured to, with the at least one processor, cause the apparatus to receive from a content provider a digital medium including digital content, an advertisement, and a separation criterion for separating the advertisement from the digital content. The apparatus is also caused to initiate presentation of the digital content and the advertisement. The apparatus is further caused to enable the selection of at least one of (1) having the received medium unmodified and played with a commercial promotion, or (2) sending the received medium unmodified to a user in which the advertisement is removed or masked on the received medium for a predetermined time period.

According to another embodiment, a computer-readable storage medium carrying one or more sequences of one or more instructions which, when executed by one or more processors, cause an apparatus to receive from a content provider a digital medium including digital content, an advertisement, and a separation criterion for separating the advertisement from the digital content. The apparatus is also caused to initiate presentation of the digital content and the advertisement. The apparatus is further caused to enable the selection of at least one of (1) having the received medium unmodified and played with a commercial promotion, or (2) sending the received medium unmodified to a user in which the advertisement is removed or masked on the received medium for a predetermined time period.

According to yet another embodiment, an apparatus comprises means for receiving, from a content provider, a digital medium including digital content, an advertisement, and a separation criterion for separating the advertisement from the digital content. The apparatus also comprises means for initiating presentation of the digital content and the advertisement. The apparatus further comprises means for enabling the selection of at least one of (1) having the received medium unmodified and played with a commercial promotion, or (2) sending the received medium unmodified to a user in which the advertisement is removed or masked on the received medium for a predetermined time period.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of freely distributing digital content with advertisement, according to one embodiment;

FIG. 2 is a diagram of the components of a digital content and advertising platform, according to one embodiment;

FIG. 3 is a flowchart of a process for determining whether and how to freely distribute digital content with advertisement, according to one embodiment;

FIG. 4 is a diagram of a user case involving a consumer experiencing digital content with an embedded advertisement, according to one embodiment;

FIG. 5 is a flowchart of an embedded advertisement process providing a watermarking advertisement, according to one embodiment;

FIG. 6 is a flowchart of an embedded advertisement process providing protected content playable by certain media players, according to one embodiment;

FIG. 7 is a flowchart of an embedded advertisement process providing conversion of ad-based content into protected content, according to one embodiment;

FIG. 8 is a presentation of a watermarking advertisement, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF SOME EMBODIMENTS

A method and apparatus for freely distributing digital content with advertisement(s) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

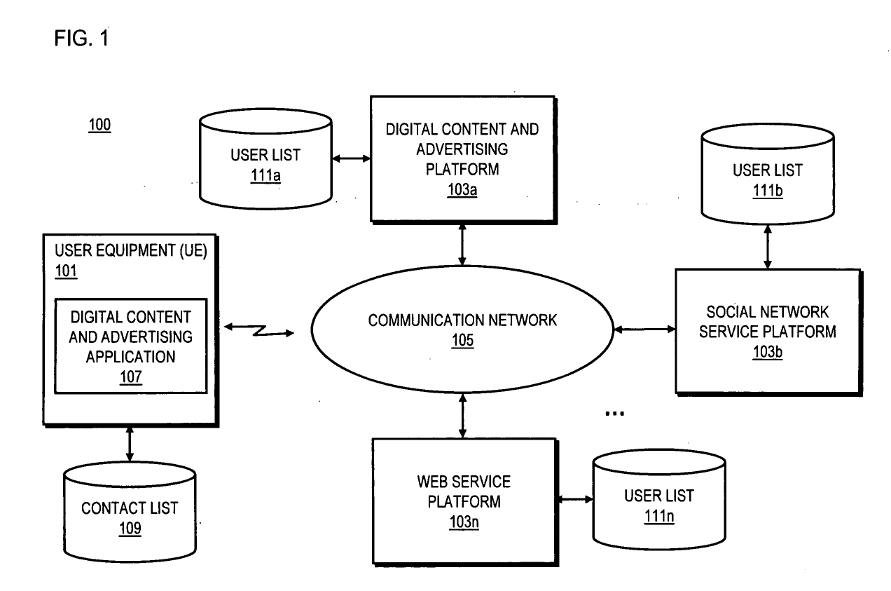

FIG. 1 is a diagram of a system capable of freely distributing digital content with advertisement(s), according to one embodiment. It is noted that digital content as captured in a digital medium is either controlled in some manner (e.g., via Digital Rights Management (DRM)) or freely shared. “Digital medium” refers to a singular medium that is a storage or transmission tool used to store and deliver information or data (including digital content). A single medium is used to communicate any data for any purpose. The digital content may comprise literary works, musical works, dramatic works, pantomimes and choreographic works, pictorial, graphics, and sculptural works, motion pictures and other audiovisual works, sound recordings, and architectural works in the formats of audio, video, graphic, and sublime which is recognizable only through subconscious, etc. The digital medium may take e.g., the form of a video clip, an interactive Flash game, an advergame, an ebook, a brandable software, an image, or a text message.

The term “Digital Rights Management (DRM)” refers to access control technologies used by e.g. hardware manufacturers, publishers, copyright holders and individuals to impose limitations on the usage of digital content and devices. For example, many online music stores employ DRM to restrict usage of music purchased and downloaded online. Most stores utilize a particular client software to be downloaded, and some stores also employ plug-ins. The term “DRM-free” refers to not apply DRM to limit the distribution of digital content. Although DRM is popular for Internet music, some online music stores do not use DRM but rather encourage users to avoid sharing the music acquired from these stores. Some online retailers sell only unsigned artists and even encourage people to share the music obtained from the site, to increase exposure for the artists. Some companies promote DRM-free music for viral marketing, especially for independent artists while focusing on revenues from higher margin products like merchandise and concert ticket sales. Considering the opposing trend by consumers against DRM, many companies and artists have begun advertising and distributing their digital content as “DRM-Free”. Major labels have begun releasing more online music without DRM.

The term “embedded advertisement” (or “sticky-ad”) refers to advertisement that is distributed together with digital content to constitute embedded advertisement digital medium and can be separated from the digital content by a content provider of the embedded advertisement digital medium. Rather than applying DRM technologies to limit the distribution of digital content as in other methods, DRM technologies or the like are applied in this application to control the separability of the advertisement from the digital content. Also, the term ‘advertiser’ refers to an advertisement sponsor (such as Coca-Cola), or an entity acting on behalf of an advertisement sponsor (such as an advertisement agency/broker), or an advertisement distributor (such as an internet search engine, an internet content provider, an internet service provider, a communication service provider, etc).

Although various embodiments are described with respect to a digital content and advertising platform, it is contemplated that the approach described herein may be used with other digital content and advertising services or widgets.

According to certain embodiments, system 100 provides an embedded advertisement (or sticky-ad) mechanism provides a number of advantages. For example, the advertisement mechanism can support content portability between devices, wherein such portability is restricted due to DRM or compatibility problems. In another example, the mechanism can provide revenue generation through DRM-free digital content while selectively removing sticky-ad under certain conditions.

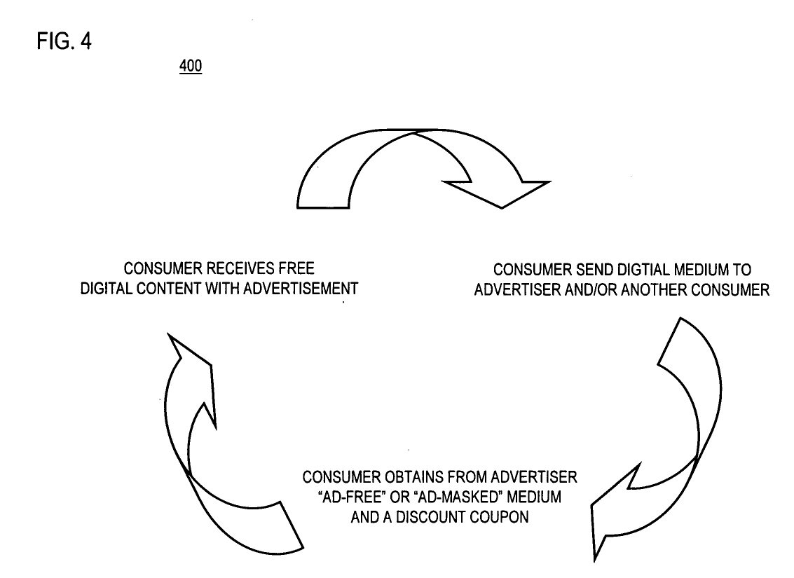

The embedded advertisement, according to certain embodiments, introduces the capability to freely distributing digital content with advertisement. This embedded advertisement process replaces DRM, removes the portability issues related to DRM, and to make digital content advertising a continuum of revenue for the content provider and also the consumers (by distributing the digital content with advertisement to other consumer thereby sharing the revenue with the content provider), as seen in FIG. 4, for example.

As shown in FIG. 1, the system 100 comprises a user equipment (UE) 101 having connectivity to a digital content and advertising platform 103 via a communication network 105. The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

By way of example, the UE 101, the digital content and advertising platform 103a, a social networking service platform 103b, and a web service platform 103n communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In exemplary embodiments, the UE 101 has connectivity to a database 111 of one or more user lists of other service platforms. The user list database 111 may include, for instance, any number of fields, including, for example, name of contact, telephone number, E-mail address, and other related information fields. Moreover, the user list may be associated with the UE 101 itself or with one or more applications running on the UE 101.

In various embodiments, the communication network 105 allows the digital content and advertising platform 103 to synchronize an existing user list (e.g., the contact list database 109) or create a new user list in the database 111 with the contact database 109 of the UE 101. For example, the digital content and advertising platform 103a may collect online personal information management (e.g., Google®, Yahoo®, etc.) including management of user contacts. It is contemplated that the digital content and advertising platform 103a may include in any service including at least in part a contact list.

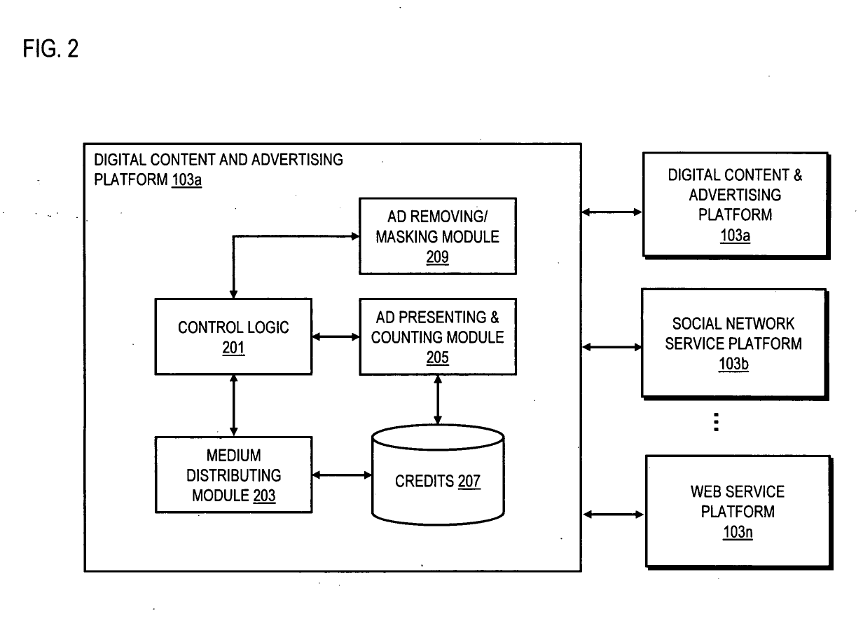

FIG. 2 is a diagram of the components of the digital content and advertising platform 103a, according to one embodiment. By way of example, the digital content and advertising platform 103a includes one or more components for providing freely distributing digital content with advertisement. It is contemplated that the functions of these components may be combined in one or more components or performed by other components of equivalent functionality. In this embodiment, the digital content and advertising platform 103a includes a control logic 201 for controlling the operations of all modules within the platform 103a, a medium distributing module 203 for distributing digital media, an advertisement presenting and counting module 205 for presenting an advertisement to the user, counting incrementally each presentation and storing the count for each user into a credits database 207, and an advertisement removing/masking module 209 for removing/masking an advertisement (thus not presenting the advertisement to the user).

Alternatively, the functions of the digital content and advertising platform 103a can be implemented via a digital content and advertising application (e.g., widget) 107 in the user equipment 101 according to another embodiment. Widgets are light-weight applications, and provide a convenient means for presenting information and accessing services. It is contemplated that the functions of these components may be combined in one or more components or performed by other components of equivalent functionality. In this embodiment, the digital content and advertising application 107 includes an off-line advertisement presenting and counting module for presenting an advertisement to the user, counting incrementally each presentation and storing the count for each user into a credits database, and an advertisement removing/masking module for removing/masking an advertisement (thus not presenting the advertisement). In yet another alternative embodiment, the functions of the digital content and advertising platform 103a are carried out collaboratively by the digital content and advertising platform 103a and the digital content and advertising application 107.

To avoid data transmission costs as well as save time and battery, the off-line modules can conduct searches on data cached or stored in its own memory, without requesting data from any servers or external platforms, such as the digital content and advertising platform 103a, the social networking service platform 103b, and the web service platform 103n. Usually, if the user equipment is online, data queries are made to online search server backends, and once the device is off-line, searches are made to off-line indexes locally.

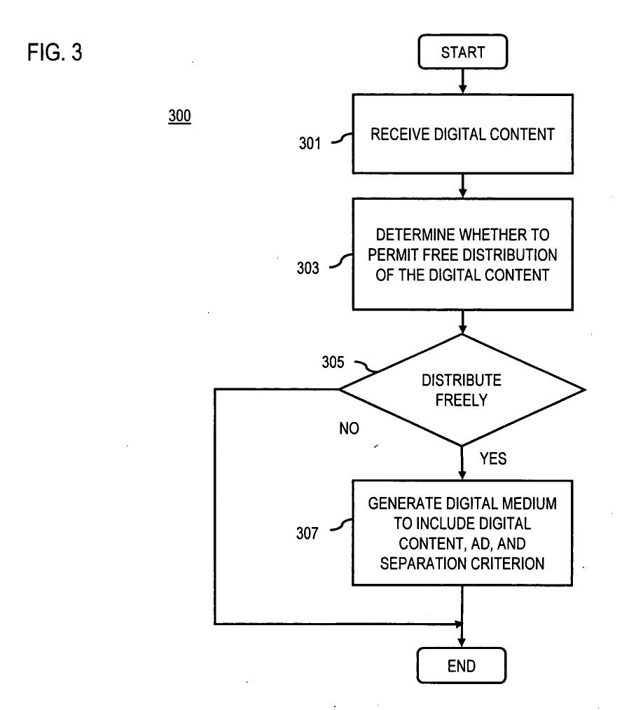

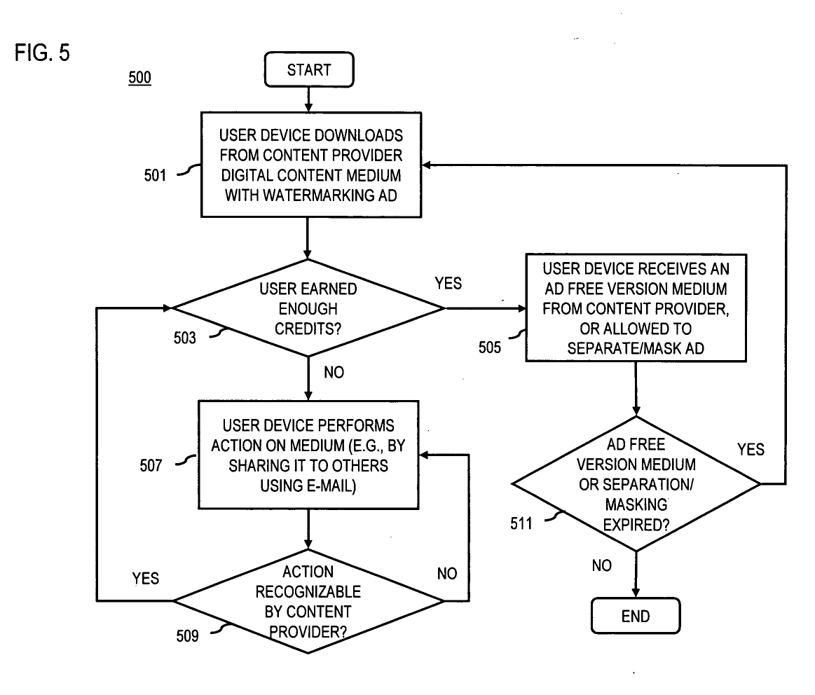

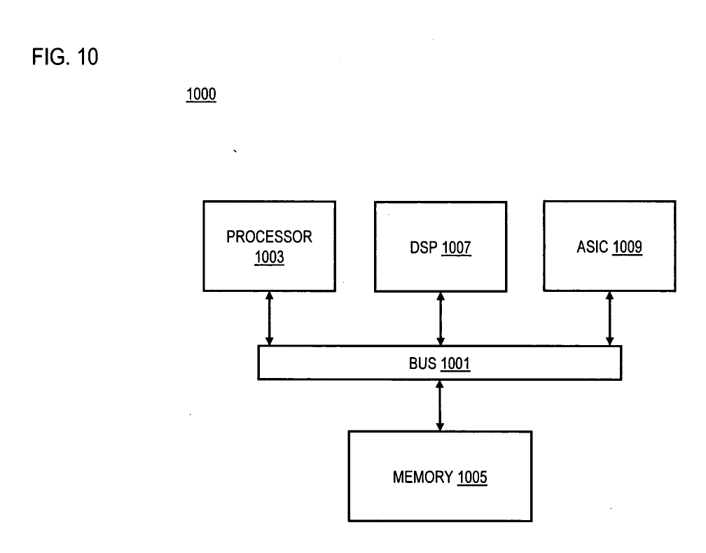

FIG. 3 is a flowchart of a process 300 for determining whether and how to freely distribute digital content with advertisement, according to one embodiment. In one embodiment, the digital content and advertising platform 103a performs the process 300 and is implemented in, for instance, a chip set including a processor and a memory as shown FIG. 10. In step 301, the digital content and advertising platform 103a receives digital content from, for example, a no-name artist or creative group. The digital content and advertisement elements can be, e.g., in audio, video, still photo, graphics, sublime or a combination thereof. The digital content and advertising platform 103a determines whether to permit free distribution of the digital content based upon commercial consideration, such as whether the digital content appears to any targeted audience of products/services and potential advertisement sponsors, whether the artist or creative group will agree to the terms and conditions of payments and free distribution of the digital content, etc. (Step 303). If the determination is “yes” in Step 305, the digital content and advertising platform 103a generates a digital medium to include the digital content, an advertisement, and a separation criterion for separating the advertisement from the digital content (Step 307). In certain embodiments, the predetermined separation criterion, for instance, is the user views/listens to the digital content and the advertisement for 10 times, or the user via, e.g., UE 101 sends the digital medium to another user. The process 300 comprises subsequent steps, such as removing DRMs, replacing the advertisement with new advertising elements, which will be explained later in conjunction with FIG. 5. If the determination is “no” in Step 305, the process 300 ends.

Under the above arrangement, the UE 101 can be configured to enable the selection of at least one of the following actions to be performed: (1) keeping the received medium as is and presenting the received medium under a set condition, thereby receiving a commercial promotion, or (2) sending the received medium as is to another device of another user thereby removing or masking the advertisement on the received medium for a predetermined time period. In one embodiment, the UE 101 can prompt the user for saving the received medium, and for retrieving the commercial promotion.

FIG. 4 is a diagram of a user case involving a consumer experiencing digital content with an embedded advertisement, according to one embodiment. In this example, an embedded advertisement circle is a complete process 400 of bringing an embedded advertisement to the consumers. By way of example, the embedded advertisement circle comprises: (1) receiving by a consumer free digital content with embedded advertisement, (2) sending by the consumer the complete medium to another consumer and the advertiser, and (3) sending from the advertiser to the consumer an ad-free or ad-masked digital medium and optionally a discount coupon as shown in FIG. 4. A consumer can share the medium or have other consumers be exposed to the (advertisements in the) media by playing it or taking other actions on it, and the digital content and advertising platform 103a can track such actions. The advertisements thus support free digital content. This enables free distribution of the content (for example, music, visual art, etc), encourages sharing of the content, and results in vastly improved user experience. Meanwhile, the digital content is monetized through the advertising elements in the digital medium. In other words, the embedded advertisement process encourages and enables free distribution of digital media and allows the generation of revenue at the same time. The sticky-ad process selectively applies RM to control separability of the advertisement from the digital content, while monetizing the usage of the digital content.

The embedded advertisement process executes viral distributions. Viral marketing/advertising comprises marketing techniques that use existing social networks of the consumers to produce/increase brand awareness and to achieve other marketing objectives (such as product sales) through self-replicating viral processes, similar to computer viruses. FIGS. 5-7 are flowcharts showing how the digital content and advertising platform 103a provides incentives for a consumer to distribute digital content with advertisement to other consumers thereby triggering viral distributions and generating revenue for the advertiser, according to various embodiments.

FIG. 5 is a flowchart of an embedded advertisement process providing a watermarking advertisement, according to one embodiment. As mentioned, in one embodiment, FIG. 5 continues from the Step 307 of FIG. 3. In the embodiment shown in FIG. 5, a user via a user device (e.g., UE 101) downloads a medium (“digital content”) generated according to the process 300 from a content provider or, after receiving an invitation from a friend or the content provider (Step 501). The content provider may be a strict content provider (e.g., news organization, magazine publisher, etc.) or a value-added service provider (VASP) which provides value-added service (VAS) beyond core services at no cost to promote their main service business. In telecommunication industry, value-added services add value to the standard services (standard voice calls and fax transmissions), spurring subscribers to use their phones more and allowing the operators to drive up their average revenue per user/unit (ARPU). For mobile phones, technologies like short message service (SMS) and multimedia messaging service (MMS) are usually considered value-added services, except involving premium-charged content.

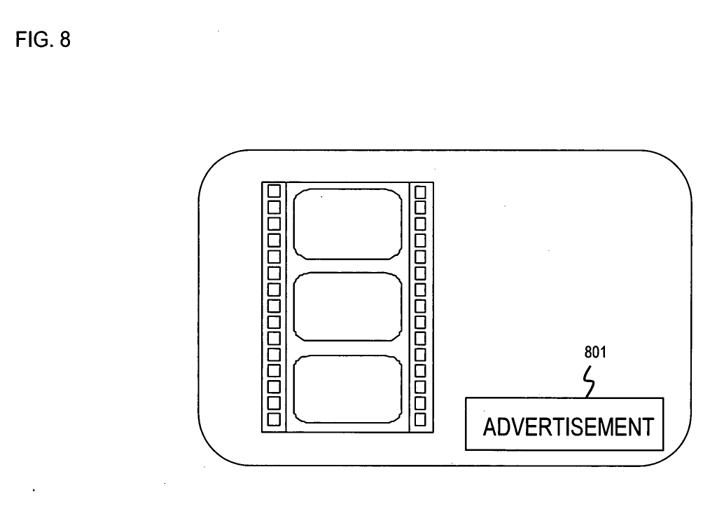

The technical implementation varies depending on the content and can be chosen between various audio, video, still photo, graphical element (for example, drawing) formats. Possible solutions are advertisements in MP3, WMA, MPEG, JPG, PNG, GIF and other currently used technology formats and new related technology formats. By way of example, the medium has a watermarking advertisement therein as shown in FIG. 8, which cannot be easily removed without compromising media quality. A user can use any player software compatible with the format to play the digital medium. But at the same time, the user is exposed to the advertisement in the digital medium. The approach may involve determining how the advertisement must be viewed before other content can be experienced. For example, some digital content can have an audio/video advertisement in the beginning or end.

Digital watermarking, in one embodiment, is the process of embedding information into a digital signal. The signal may be audio, pictures or video. If the signal is copied, then the information is also carried in the copy. In visible watermarking, the information is visible in the picture or video. In the some DRM implementations, the information is typically text or a logo which identifies the owner of the medium. For example, when a television broadcaster adds its logo to the corner of transmitted video, this is also a visible watermark. However, the watermark shown in FIG. 8 has visible ADVERTISEMENT 801 embedded in an image. The digital watermark is robust with respect to transformations. Even if the embedded information can reliably be detected from the marked signal, it is still visible after being degraded by a number of transformations. Typical image degradations are Joint Photographic Experts Group (JPEG) compression, rotation, cropping, additive noise and quantization. For video content temporal modifications and Motion Pictures Experts Group (MPEG) compression are often added to this list.

As another example, if the digital content is a computer game or a sports game, the sticky-ad process inserts product placement in the game. Virtual product placement is adapted to enhance the advertisement. Product placement, or embedded marketing, is a form of advertisement, where branded goods or services are placed in a context usually devoid of advertisements, such as the story line of the computer game. The product placement often does not explicitly disclose the featured goods or services.

By way of example, the system 100 uses computer graphics to insert the featured products/services into the digital content after the digital content is complete. The system 100 also uses existing post production tools to insert new product placement images and billboard advertising, notable in televised at baseball and hockey games, and switch product placement beyond sports arenas. For sports arenas, the geometrical relationships of camera and the surface of the flat area onto which the billboard is projected can be easily calculated.

By using the user information stored in the social network service platform 103b and the web service platform 103c, the system 100 can insert product placement targeting customers with different products and dynamically switches the advertisements based upon such factors as demographics, psychographics or behavioral information about the consumers. For example, when user downloads a computer game on dragon fighting, the system 100 embeds in-game advertisements for other similar games. As another example, the system 100 changes displayed advertisements on the fly when user switch from an advertisement of barbeque sauce embedded in a video clip produced by a channel dedicated to foods to an advertisement of tents in a video clip produced by another channel dedicated to travel.

According to one embodiment, the user can perform certain actions on the digital medium to earn credits, such as playing once in an IM application for one credit or sharing it to another user using P2P peer-to-peer (P2P) for 10 credits. Another incentive for viral distribution as well as motivating the user to send the digital medium to many other users is cash rewards, i.e., sharing advertising revenue with the consumers.

If user has not yet earned sufficient credits (e.g., 10 credits) by these actions (Step 503), the user may take more actions to earn more credits (Step 507). Each action will be evaluated by the content provider to determine whether such action falls within the recognizable set of actions that accrue credits (Step 509). Credits on an action are acknowledged when the action is recognizable by the content provider. For example, a digital medium sharing action is recognizable by a content provider if the user uses an e-mail interface supported by the content provider to share a medium. But it is not recognizable, if user uses e-mail interface of other service providers. A filtering mechanism is provided to serve at least two purposes: to ensure that the user is not sending to his/her own accounts under different names, and to boost the usage of the content provider's web services. In certain embodiments, a user can keep as many media as the user wishes. Additionally, different users may accumulate different numbers of credits on an identical media.

When the user earns sufficient credits (e.g., predetermined threshold) by these actions, the content provider offers the user an advertisement-free or advertise-masked version of the medium, e.g. via an email (Step 505). In one embodiment, it is contemplated that ad-supported content (in which content (e.g., ads) may time-out or expire) can be adapted to make the digital medium become ad-free. According to one embodiment, users may be able to remove the advertisement themselves after listening to an advertisement for a configurable number of times. In step 511, the process determines whether the ad free version of the medium or the separation/masking capability has expired; if so, the process returns to step 501. This embodiment employs DRM or similar technologies, which is not completely DRM-free.

According to one embodiment, the system 100 provides the users with the capability to remove/mask the advertisement themselves, and encourages them to do so. For example, if the user removes an advertisement and sends it to the content provider, the user gets “10% off the next purchase” under a particular promotion code.

By way of example, digital content is generated by promising, yet relatively unknown bands/artists/writers/game developers. The band/artist/developer agrees to use an arrangement, according to certain embodiments, as a stepping stone for their career. The content provider may include the generated content, such as a free song, with a sold item to tie the content and the corresponding brand together. Free sharing among consumers might be seen as improving customer retention for the content provider. Sharing content, such as music/video/games/books, according to one or more embodiments may also create/strengthen social communities and generate revenue through ads and merchandise, for the content provider.

For example, the user receives from a friend a digital medium including a song from a band and an advertisement for a grand opening of a new department store with the performance of the same band. The user plays the song along with an advertisement, and, according to example embodiment, the user can then choose (1) to keep the advertisement in the digital medium as is and receive a promotional code for a discount of items sold in the department store or a discount of a live concert by the band, or (2) to remove/mask the advertisement for a time period (for example, for a month) by sending the song with the advertisement to another friend. In other words, the sharing of the medium is encouraged by removing/masking the advertisement for the time period. If the second option, (2), is selected, the advertisement will be returned to or unmasked on the digital medium after the time period. Alternatively, the advertisement may be replaced with another advertisement, when the digital medium is played on a compatible player that is connected to the Internet via network 105.

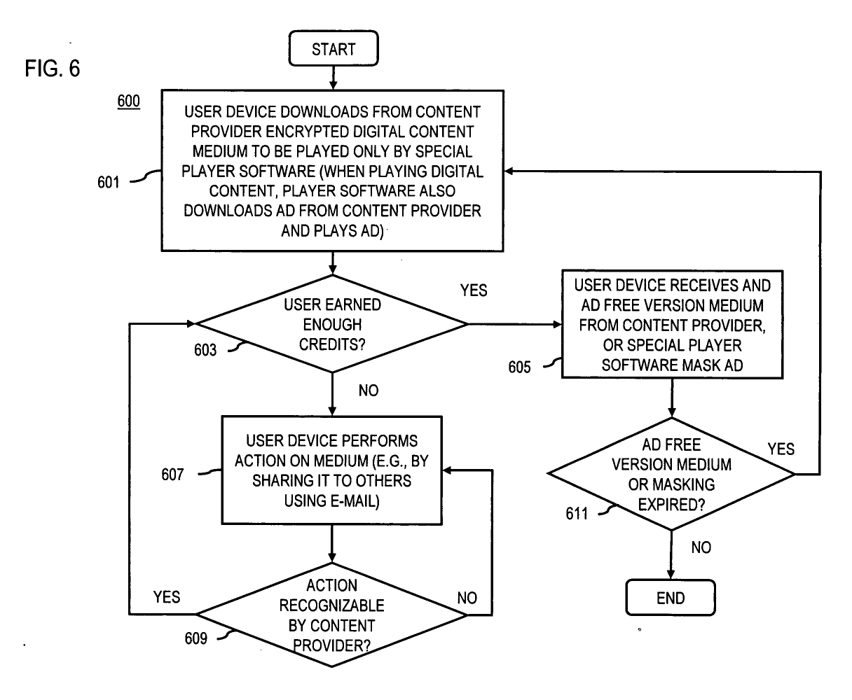

FIG. 6 is a flowchart of an embedded advertisement process, according to another embodiment. This process is similar to that of FIG. 5, however, under this scenario, the medium is either downloaded from a content provider or received from another user (e.g., a friend of the user, and is encrypted. As such, the medium can only be played by a certain player software or playing device specified by the content provider. Although the digital medium is DRM protected, the user can still freely distribute/copy the digital medium to another computer or share the digital medium with other users using for example P2P. The digital medium can be played on different computers as long as a user uses the specified player software or playing device. The digital medium includes advertisements to be play along with the digital content. The specified player software or playing device is controlled by the content provider to present the advertisements under predetermined conditions.

Alternatively, the digital medium is not embedded with advertisements. However, when the digital medium is played by the specified player software or playing device, the specified player software or playing device (i.e., user device) may download advertisements from a content provider and present advertisements, e.g. using advertising middleware (Step 601). Steps 603-609 of FIG. 6 mirror that of steps 503-509 of FIG. 5. By analogy, the specified player software or playing device does not present advertisements when it plays an ad-free digital medium or when the advertisement is masked (Step 605). In with step 511 of FIG. 5, this process determines, in step 611, whether the ad free version of the medium or the separation/masking capability has expired; if so, the process returns to step 601. In yet another alternative, some advertisements may reside in the UE 101 preloaded, or acquired in connection with some other action, such that no additional downloading is required. The suitability of the advertisements that are already stored in the user equipment to the current action, such as playing of the digital medium, may be determined by, e.g., the specified player software of device

If this special player software/device is linked to digital content and advertising platform 103a by a specific user identifier, and if the digital content and advertising platform 103a determines that the user is qualified by sharing sticky-ad-enabled medium or by other conditions (e.g., the user pays certain money or buys a premium subscription), the digital content and advertising platform 103a allows the user to use this player software/device to play any (or selected) medium without any advertisements under certain conditions (e.g. 10 days).

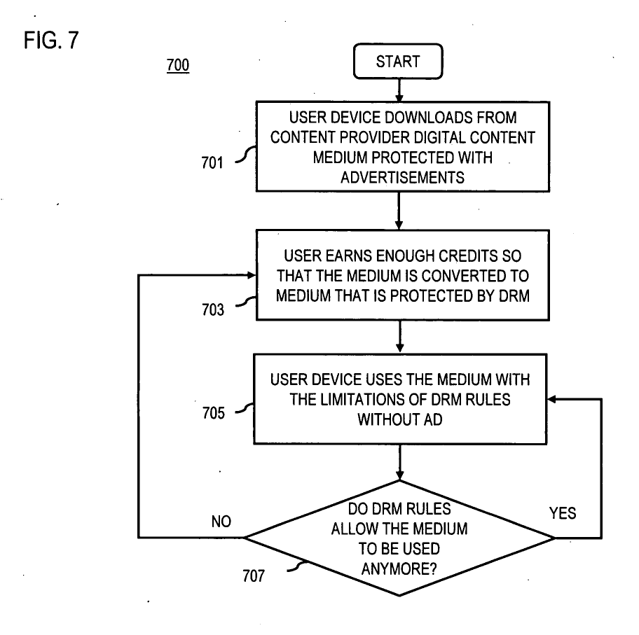

FIG. 7 is a flowchart of an embedded advertisement process providing conversion of ad-based content into protected content, according to a third embodiment. In this third embodiment, a user either downloads a digital medium from a content provider or receives a digital medium from another user, e.g., a friend (Step 701). The digital medium is protected by advertisements either using watermarking as in one example embodiment (FIG. 5) or using the specified player software or playing device as in another example embodiment (FIG. 6). In either way, the user tries to earn credits that are recognizable by the content provider. When user has enough credits (Step 703), the content provider offers user an ad-free or ad-masked version of the digital medium (Step 705). The DRM rules are decided by the content provider, e.g. DRM-free for 1 month. The user can enjoy the digital content with the limitation of the DRM rules without being bothered with advertisements. But when the DRM-free medium expires due to the DRM rules, the user has to utilize the old version that is protected by advertisements (Step 707).

Regarding privacy concerns, the system 100 ensures the details of a consumer who receives distributed digital content are not revealed to any entity without the consumer's approval. The system 100 contacts consumers only after the consumers “opt-in” to a communication marketing program. The system 100 gains approval from the consumers before invitations to retrieving digital media and sending digital media, and each digital medium includes clear directions on how to unsubscribe from communication should it become unwanted. Further, the system 100 gives the consumers control of when and how they receive marketing messaging and digital media on their user equipments and allows the consumers to easily terminate or “opt-out” of an unwanted digital medium and advertisement. The system 100 tailors advertisements to the interests of the consumer (e.g. restricting communications to those categories specifically requested by the consumer) based upon data supplied by the consumers and marketing data, so as to eliminate spam and make advertisements as relevant and useful to the consumers as possible. The system 100 does not share consumer information with non-affiliated third-parties.

The processes described herein for providing freely distributing digital content with advertisement may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

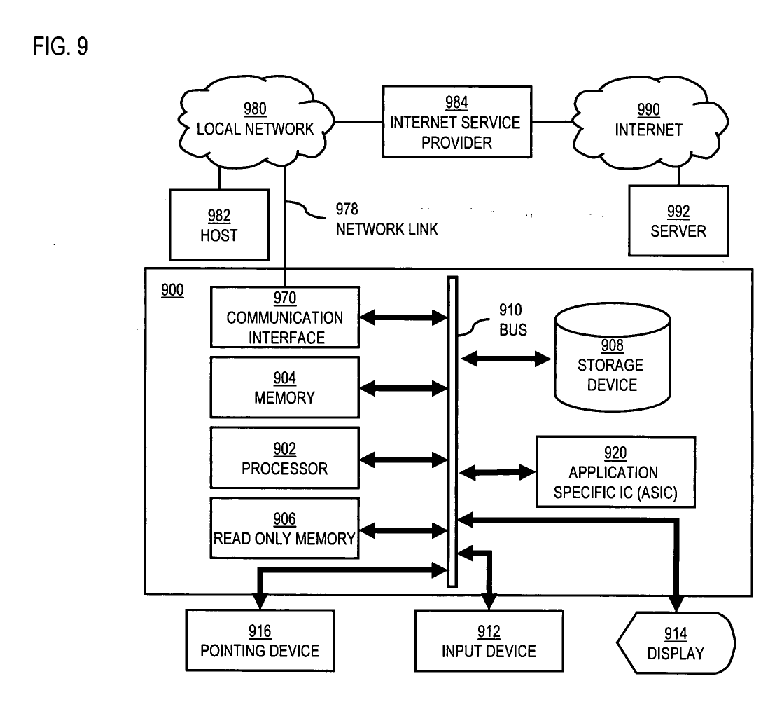

FIG. 9 illustrates a computer system 900 upon which an embodiment of the invention may be implemented. Computer system 900 is programmed to freely distributing digital content with advertisement as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information related to freely distributing digital content with advertisement. The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for freely distributing digital content with advertisement. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for freely distributing digital content with advertisement, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for freely distributing digital content with advertisement to the UE 101.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to freely distributing digital content with advertisement as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to freely distributing digital content with advertisement. The memory 1005 also stores the data associated with or generated by the execution of the inventive steps.

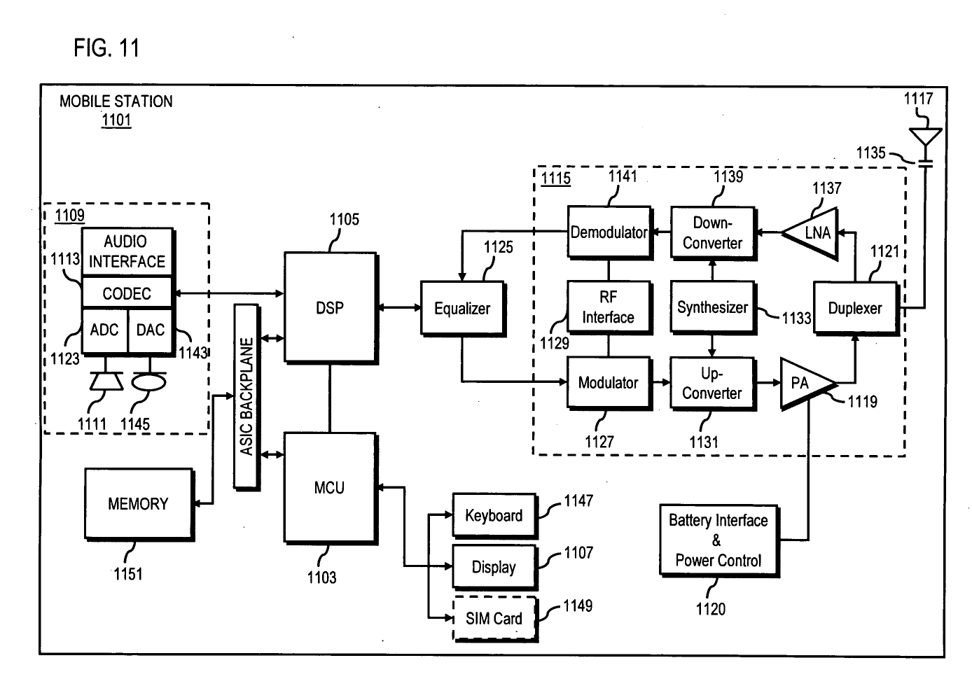

FIG. 11 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to freely distributing digital content with advertisement. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

The embedded advertisement (or sticky-ad) process encourages the sharing of digital content without restrictions from peer to peer. Current DRM technologies attempt to restrict sharing and to keep distribution between business and consumers.

The sticky-ad process can be readily applied to digital content of creative works for all companies that want to place advertisement in digital content for their products/services, such as, but not limited to, fashion industry, car industry, travel industry, music industry, movie industry, etc. The method can be used by the products/services directly, or by any third party content providers such as newspapers, online bookstores, telephone companies, etc.

The sticky-ad process can be adapted to various areas of digital content (music, video, games, books, etc.) based upon their similarities and differences of their characteristics as a media and as a channel for advertising. The “advertising circle” works with any digital content that can be shared peer to peer. The advertisement content may vary depending on the form of the content (music, video, etc.).

The sticky-ads do not limit portability, encourage sharing while providing advertising space and audience, are removable but yet returned once played on a certain player connected to the Internet, updateable, and earn revenue through advertising while keeping digital content free for consumers.

The sticky-ad process enables businesses to bypass the expense and shortcomings of traditional mass marketing, and advertise directly to the consumers most likely to patronize the businesses. The sticky-ad process is designed to efficiently achieve a profitable result for the content providers and merchants.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving digital content;
determining whether to permit free distribution of the digital content; and
generating a digital medium to include the digital content, an advertisement, and a separation criterion for separating the advertisement from the digital content.

2. A method of claim 1, further comprising embedding the advertisement in the digital content.

3. A method of claim 1, further comprising:
initiating sending the medium to a device of a first user, wherein the digital content and the advertisement is configured to be presented in the device, wherein the device is further configured to enable the selection of at least one of the following actions to be performed: (1) keeping the received medium as is and presenting the received medium under a set condition thereby receiving a commercial promotion, or (2) sending the received medium as is to another device of a second user thereby removing or masking the advertisement on the received medium for a predetermined time period.

4. A method of claim 3, wherein the device is further configured to cause prompting for saving the received medium, and for retrieving the commercial promotion.

5. A method of claim 3, wherein the device is further configured to cause returning the advertisement or a different advertisement to the medium after the predetermined time period.

6. A method of claim 1, wherein the medium is encrypted to be played by a predetermined playing program or device, and the advertisement is downloaded by the predetermined playing program or device when playing the digital content.

7. A method of claim 1, further comprising:
initiating sending of the medium as is to a device through a designated interface to be acknowledged by a content provider.

8. An apparatus comprising:
at least one processor; and
at least one memory including computer program code,
wherein the at least one memory and the computer program code configured to, with the at least one processor, cause the apparatus to perform at least the following:
receive digital content;
determine whether to permit free distribution of the digital content; and
generate a digital medium to include the digital content, an advertisement, and a separation criterion for separating the advertisement from the digital content.

9. An apparatus of claim 8, wherein the apparatus is further caused to embed the advertisement in the digital content.

10. An apparatus of claim 8, wherein the apparatus is further caused to:
initiate sending the medium to a device of a first user from a content provider, wherein the digital content and the advertisement is configured to be presented in the device,
wherein the device is further configured to enable the selection of at least one of the following actions to be performed: (1) keeping the received medium as is and presenting the received medium under a set condition thereby receiving a commercial promotion, or (2) sending the received medium as is to another device of a second user thereby removing or masking the advertisement on the received medium for a predetermined time period.

11. An apparatus of claim 10, wherein the apparatus is further caused to prompt for saving the received medium, and for retrieving the commercial promotion.

12. An apparatus of claim 10, wherein the apparatus is further caused to return the advertisement or a different advertisement to the medium after the predetermined time period.

13. An apparatus of claim 8, wherein the medium is encrypted to be played by a predetermined playing program or device, and the advertisement is downloaded by the predetermined playing program or device when playing the digital content.

14. An apparatus of claim 8, wherein the apparatus is further caused to initiate sending the medium as is to a device through a designated interface to be acknowledged by a content provider.

15. A method comprising:
receiving, from a content provider, a digital medium including digital content, an advertisement, and a separation criterion for separating the advertisement from the digital content;
initiating presentation of the digital content and the advertisement; and
enabling the selection of at least one of (1) having the received medium unmodified and played with a commercial promotion, or (2) sending the received medium unmodified to a user in which the advertisement is removed or masked on the received medium for a predetermined time period.

16. A method of claim 15, further comprising:
initiating storage of the received medium; and
retrieving the promotion from a sponsor of the advertisement.

17. A method of claim 15, further comprising:
removing the advertisement from the received medium for the predetermined time period;
initiating sending of the received medium to the user; and
receiving the advertisement or a different advertisement associated with the medium after the predetermined time period.

18. An apparatus comprising:
at least one processor; and
at least one memory including computer program code,
wherein the at least one memory and the computer program code configured to, with the at least one processor, cause the apparatus to perform at least the following:
receive from a content provider a digital medium including digital content, an advertisement, and a separation criterion for separating the advertisement from the digital content;
initiate presentation of the digital content and the advertisement; and
enable the selection of at least one of (1) having the received medium unmodified and played with a commercial promotion, or (2) sending the received medium unmodified to a user in which the advertisement is removed or masked on the received medium for a predetermined time period.

19. An apparatus of claim 18, wherein the apparatus is further caused to:
initiate storage of the received medium; and
retrieve the promotion from a sponsor of the advertisement.

20. An apparatus of claim 18, wherein the apparatus is further caused to:
remove the advertisement from the received medium for the predetermined time period;
initiate sending of the received medium to the user; and
receive the advertisement or a different advertisement associated with the medium after the predetermined time period.
